(19) United States
(12) Patent Application Publication
(10) Pub. No.: US 2026/0316812 A1
(43) Pub. Date: Oct. 15, 2026

(54) FOLDABLE STROLLER

(71) Applicant: Graco Children’s Products Inc., Atlanta, GA (US)

(72) Inventor: Hitoshi Yabuuchi, Tokyo (JP)

(73) Assignee: Graco Children’s Products Inc., Atlanta, GA (US)

(21) Appl. No.: 19/639,617

(22) Filed: Apr. 6, 2026

(30) Foreign Application Priority Data
Apr. 15, 2025 (JP) 2025-067045

(51) Int. Cl. B62B 7/08; B62B 7/10; B62B 9/08

(52) U.S. Cl. CPC B62B 7/08; B62B 7/10; B62B 9/087

(57) ABSTRACT

A foldable stroller includes: a body frame including front legs and rear legs, the body frame having different configurations in a deployed state and a folded state; a caster mechanism provided at a lower end of at least one of the front legs or the rear legs and configured to allow a wheel to swivel; and a rotation lock member configured to lock the wheel against rotation, the rotation lock member being displaceable between a locking position at which the wheel is locked against rotation and an unlocking position at which the wheel is not locked against rotation. The rotation lock member is configured to be displaced from the unlocking position to the locking position in association with movement of the body frame from the deployed state to the folded state.

### BACKGROUND

The present invention relates to foldable strollers, and more particularly to a foldable stroller that is in a deployed state during use and in a folded state when not in use.

Foldable strollers that are in a deployed state during use and in a folded state when not in use are known. Examples of such foldable strollers are disclosed in Japanese Unexamined Patent Application Publication Nos. 2015-151050, 2013-095274, and 2013-006553.

Japanese Unexamined Patent Application Publication No. 2015-151050 discloses that when the stroller is changed from the deployed state to the folded state, a pressing member presses a movable member, thereby causing a caster lock member to lock a caster holder against swiveling. Japanese Unexamined Patent Application Publication No. 2013-095274 discloses that a known lock lever capable of locking a caster wheel against swiveling is provided, and that the caster wheel is locked against swiveling when the stroller operator operates the lock lever. Japanese Unexamined Patent Application Publication No. 2013-006553 discloses that a caster wheel provided at the lower end of a front leg is locked against swiveling by a caster lock member in response to displacement of a front-leg-side movable member to an upper position or a lower position.

### SUMMARY

In each of the strollers disclosed in Japanese Unexamined Patent Application Publication Nos. 2015-151050, 2013-095274, and 2013-006553, the caster wheels are locked against swiveling when the stroller body changes from the deployed state to the folded state, thereby improving the folding operation of the stroller. However, the inventors have found through further study that locking the caster wheels against swiveling alone is not sufficient when considering stability during the folding operation of the stroller.

The present invention has been made in view of the above circumstances, and an object of the invention is to provide a foldable stroller that can improve the stability of the folding operation.

A foldable stroller according to one aspect of the present invention includes: a body frame including front legs and rear legs, the body frame having different configurations in a deployed state and a folded state; a caster mechanism provided at a lower end of at least one of the front legs or the rear legs and configured to allow a wheel to swivel; and a rotation lock member configured to lock the wheel against rotation, the rotation lock member being displaceable between a locking position at which the wheel is locked against rotation and an unlocking position at which the wheel is not locked against rotation. The rotation lock member is configured to be displaced from the unlocking position to the locking position in association with movement of the body frame from the deployed state to the folded state.

Preferably, the foldable stroller further includes an operating member provided on the body frame and operable to move the body frame from the deployed state to the folded state.

Preferably, the body frame further includes a first frame and a second frame connected via a pivot shaft, and the body frame is configured to, as configurations of the first frame and the second frame change, pivot about the pivot shaft and fold such that the front legs and the rear legs move closer to each other in a front-rear direction.

Preferably, the foldable stroller further includes a displacement member provided on the body frame and connected to the rotation lock member via a connecting member, the displacement member being displaceable between a first position corresponding to the unlocking position of the rotation lock member and a second position corresponding to the locking position of the rotation lock member in association with movement of the body frame from the deployed state to the folded state.

Preferably, the displacement member is provided at the pivot shaft.

Preferably, the displacement member includes: a movable member connected to the operating member via a first connecting member and configured to move in response to operation of the operating member; a follower member connected to the rotation lock member via a second connecting member; and a transmission member provided between the movable member and the follower member and configured to move with movement of the movable member and transmit the movement to the follower member.

Preferably, the movable member and the transmission member are movable in an axial direction of the body frame, and the follower member is movable in an up-down direction along the body frame.

Preferably, the foldable stroller further includes a biasing member configured to bias the displacement member toward the first position.

Preferably, the caster mechanism is provided at the lower end of the front leg, and the rotation lock member is configured to lock a rear wheel provided at the lower end of the rear leg against rotation.

The foldable stroller of the present invention can improve the stability of the folding operation.

### BRIEF DESCRIPTION OF THE DRAWINGS

FIG. 1 shows side views of a foldable stroller according to a first embodiment of the present invention, where FIG. 1(A) shows a deployed state, FIG. 1(B) shows a folding intermediate state, and FIG. 1(C) shows a folded state.

FIG. 2 is an enlarged view of the front wheel shown in FIG. 1(A).

FIG. 3 shows the front wheel of FIG. 2 oriented forward.

FIG. 4 schematically shows an internal structure of the foldable stroller according to the first embodiment of the present invention, where FIG. 4(A) shows the deployed state and the folded state, and FIG. 4(B) shows the folding intermediate state.

FIG. 5 schematically shows an internal structure of the foldable stroller according to the first embodiment of the present invention, where FIG. 5(A) shows the deployed state, FIG. 5(B) shows the folding intermediate state, and FIG. 5(C) shows the folded state.

FIG. 6 schematically shows a relationship between a rotation lock member and a rear wheel according to the first embodiment of the present invention, where FIG. 6(A) shows an unlocked state and FIG. 6(B) shows a locked state.

FIG. 7 schematically shows an internal structure of a foldable stroller according to a second embodiment of the present invention, where FIG. 7(A) shows the deployed state and the folded state, and FIG. 7(B) shows the folding intermediate state.

FIG. 8 schematically shows a relationship between a rotation lock member and a wheel according to a third embodiment of the present invention, where FIG. 8(A) shows an unlocked state and (B) shows a locked state.

FIG. 9 schematically shows an internal structure of a foldable stroller according to the third embodiment of the present invention, where FIG. 9(A) shows an unlocked state and (B) shows a locked state.

FIG. 10 is a perspective view of the rotation lock member according to the third embodiment of the present invention.

### DETAILED DESCRIPTION

Embodiments of the present invention will be described in detail with reference to the drawings. The same or corresponding portions are denoted by the same reference signs throughout the drawings, and description thereof will not be repeated.

### Overview of Foldable Stroller

First, an overall configuration of a foldable stroller 1 will be described.

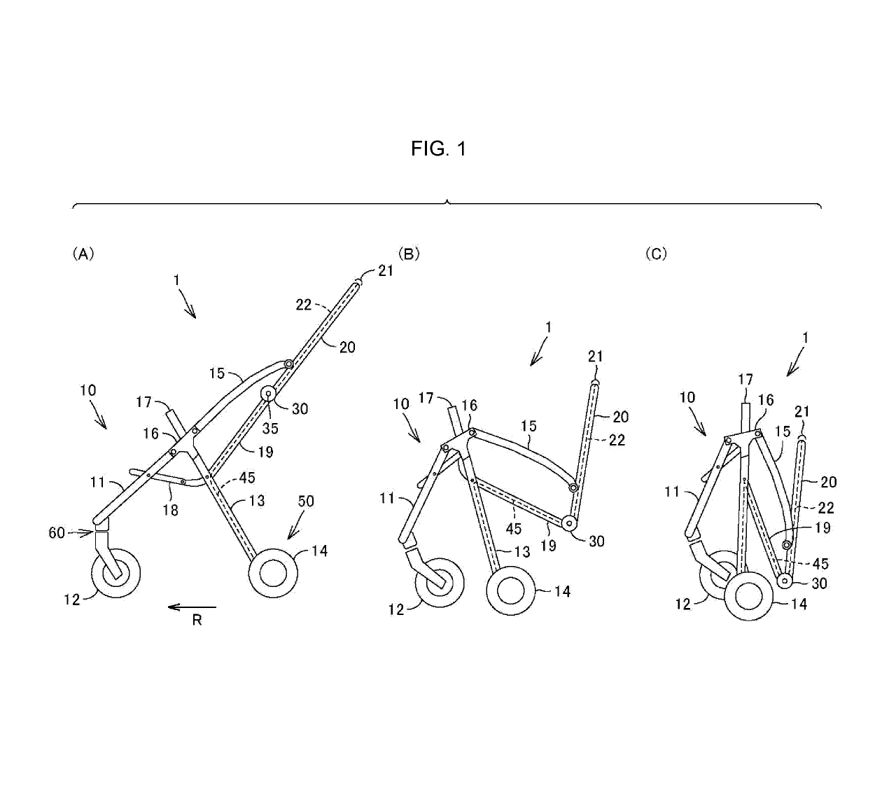

FIG. 1 shows side views of the foldable stroller 1 according to a first embodiment of the present invention. FIG. 1(A) shows a deployed state in which the foldable stroller 1 is used, FIG. 1(B) shows a folding intermediate state, which is an intermediate state between the deployed state and the folded state, and FIG. 1(C) shows a folded state in which the foldable stroller 1 is not in use. The foldable stroller 1 is maintained in either the deployed state shown in FIG. 1(A) or the folded state shown in FIG. 1(C). For ease of understanding of the invention, FIG. 1 mainly illustrates the body frame, and illustration of components such as an infant seat is omitted. In the following description, the front-rear direction corresponds to the front-rear direction of the stroller, and the left-right direction (width direction) corresponds to the left-right direction as viewed from the front of the stroller. In the following description, the foldable stroller is simply referred to as stroller.

The stroller 1 of the present embodiment includes a body frame 10 that includes a pair of front legs 11, a pair of rear legs 13, armrests 15, T-shaped brackets 16, a front guard 17, seat support members 18, backrest support members 19, and a push bar 20. The members of the body frame 10 other than the front guard 17 and the push bar 20 are provided as left and right pairs spaced apart in the width direction (the width direction of the stroller).

The front legs 11 extend in the up-down direction. A front-wheel caster mechanism 60 is provided at the lower end of each front leg 11, and a front wheel 12 is provided at the lower end of each front leg 11 via the corresponding front-wheel caster mechanism 60. The rear legs 13 extend in the up-down direction behind the front legs 11. A rear wheel 14 is provided at the lower end of each rear leg 13. Specifically, in the present embodiment, the front wheels 12 are caster wheels that can swivel 360° about a vertical axis, and the rear wheels 14 are fixed wheels that cannot swivel, rather than caster wheels. However, the rear wheels 14 may alternatively be caster wheels. That is, a rear-wheel caster mechanism may be provided at the lower end of each rear leg 13, and a rear wheel 14 may be provided at the lower end of each rear leg 13 via the corresponding rear-wheel caster mechanism. At least one of the front wheels 12 or the rear wheels 14 may be provided with a brake member (not shown) for stopping movement of the stroller 1.

The upper end of the front leg 11, the upper end of the rear leg 13, and the lower end of the armrest 15 are connected to the T-shaped bracket 16. The upper end of the front leg 11 and the lower end of the armrest 15 are rotatably connected to the T-shaped bracket 16, whereas the upper end of the rear leg 13 is fixed to the T-shaped bracket 16 so as not to rotate relative to the T-shaped bracket 16. The front guard 17 is fixed to the T-shaped bracket 16 at a position opposite the connection portion with the rear leg 13.

The upper end of the armrest 15 is rotatably connected to a lower portion of the push bar 20. The push bar 20 is, for example, substantially in an inverted U-shape, and an operating member 21 for performing a folding operation is provided at the upper end of the push bar 20. The push bar 20 is not switchable between a forward-facing position and a rear-facing position, but is fixed in the forward-facing position. Accordingly, the stroller 1 is configured to be pushed from behind. The push bar 20 is rotatably connected to the upper end of the backrest support member 19 via a pivot shaft 35. A lower portion of the backrest support member 19 is rotatably connected to an intermediate portion of the rear leg 13 and is also rotatably connected to the rear end of the seat support member 18. A front portion of the seat support member 18 is rotatably connected to an intermediate portion of the front leg 11.

The seat support member 18 supports a seat portion of an infant from below, and the backrest support member 19 supports a backrest portion of the infant from below. Although not shown in the figures, a hammock is suspended between the seat support members 18 and the backrest support members 19, and a cushion is attached to the hammock. A seat surface that forms the seat portion is thus formed on the seat support members 18, and the seat support members 18 support the seat surface from below.

When the operating member 21 of the push bar 20 is operated, the body frame 10 of the stroller 1 is displaced from the deployed state shown in FIG. 1(A) to the folded state shown in FIG. 1(C) via the folding intermediate state shown in FIG. 1(B). In the deployed state shown in FIG. 1(A), the front leg 11 and the armrest 15 extend linearly relative to the T-shaped bracket 16, and the backrest support member 19 and the push bar 20 extend linearly relative to the pivot shaft 35. In contrast, in the folded state shown in FIG. 1(C), the front leg 11 and the armrest 15 are bent at the T-shaped bracket 16, and the backrest support member 19 and the push bar 20 are bent at the pivot shaft 35. As a result, the body frame 10 is significantly reduced in size in the front-rear direction and in the up-down direction when in the folded state.

In the deployed state shown in FIG. 1(A), the front guard 17 extends across the front of the seat of the stroller 1. In contrast, in the folded state shown in FIG. 1(C), the front guard 17 becomes the uppermost portion of the folded stroller 1 and serves as a handle for grasping the folded stroller 1.

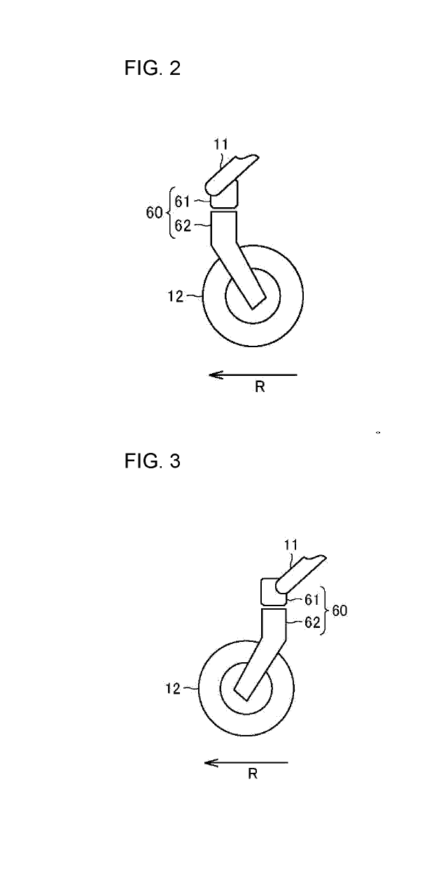

FIG. 2 shows the front wheel 12 of the stroller 1 in a traveling state. As shown in FIG. 2, the front wheel 12 is a caster wheel provided on the front leg 11 via the front-wheel caster mechanism 60 and therefore moves while oriented rearward, that is, in a direction opposite to the direction of travel R. The front-wheel caster mechanism 60 enables swiveling of the front wheel 12, and includes a caster holder member 61 fixed to the lower end of the front leg 11 and a caster pivot member 62 disposed below the caster holder member 61. Preferably, the front-wheel caster mechanism 60 is not provided with a caster lock that locks the caster wheel against swiveling. For ease of understanding, the forward direction (direction of travel) is indicated by arrow R in FIGS. 1(A), 2 and 3.

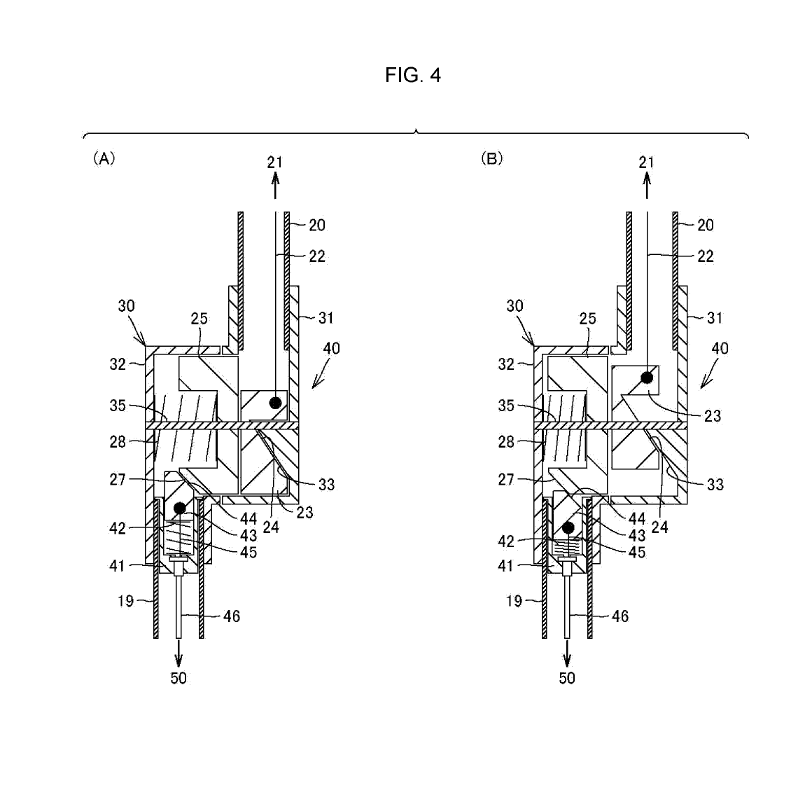

However, when the stroller 1 is displaced from the deployed state to the folded state while the front wheel 12 is oriented rearward, the stroller body may become unstable and may tip over. Therefore, in order to avoid the stroller 1 tipping over during folding, before the stroller 1 is displaced from the deployed state to the folded state, the stroller 1 needs to be first pulled backward so that the front wheel 12 is oriented forward as shown in FIG. 3, thereby stabilizing the stroller body. This method is undesirable from the viewpoint of usability because the user needs to perform an operation before folding the stroller 1.

Accordingly, the inventors conducted further studies and found that when the rear wheels 14 are locked against rotation during the folding operation, the stroller body remains stable and does not tip over regardless of the orientation of the front wheels 12. A specific internal structure of the stroller 1 capable of locking the rear wheels 14 against rotation in association with displacement from the deployed state to the folded state will be described below.

### First Embodiment

### Configuration

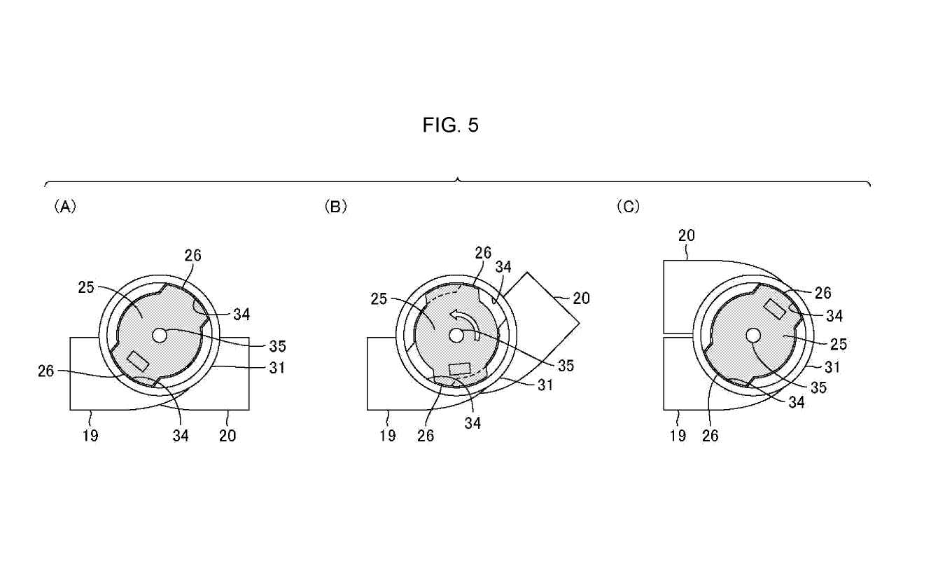

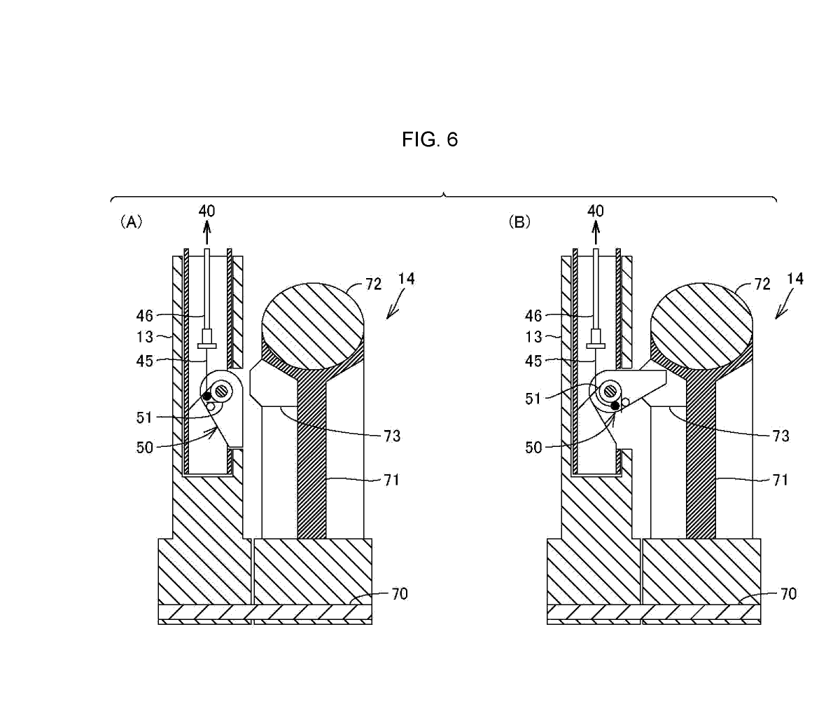

The internal structure of the stroller 1 according to the first embodiment will now be described with reference to FIGS. 1(A)-1(C) and 4-6. FIG. 4 schematically shows the internal structure of the stroller 1 according to the first embodiment of the present invention. FIG. 4(A) shows the deployed state and the folded state, and FIG. 4(B) shows the folding intermediate state. FIG. 5 schematically shows the internal structure of the stroller 1 according to the first embodiment. FIG. 5(A) shows the deployed state, FIG. 5(B) shows the folding intermediate state, and FIG. 5(C) shows the folded state. FIG. 6 schematically shows a relationship between a rotation lock member and the rear wheel. FIG. 6(A) shows an unlocked state, and FIG. 6(B) shows a locked state. For ease of understanding, connecting members 22, 45 are shown by dashed lines in FIGS. 1(A)-1(C).

In the stroller 1 of the present embodiment, a rotation lock member 50 provided on the rear wheel 14 is displaced from an unlocking position (FIG. 6(A)) to a locking position (FIG. 6(B)) in association with displacement of the stroller 1 from the deployed state (FIG. 1(A)) to the folded state (FIG. 1(C)). More specifically, when the operating member 21 provided on the push bar 20 shown in FIG. 1(A) is operated, the first connecting member 22 is pulled upward, causing a displacement member 40 provided at the pivot shaft 35 to be displaced. As a result, the second connecting member 45 is pulled upward and the rotation lock member 50 is displaced to the locking position.

As shown in FIGS. 1(A) and 4(A), the first connecting member 22 connects the operating member 21 and the displacement member 40 inside a pivot member 30. More specifically, the first connecting member 22 passes through the pipe-shaped push bar 20. The upper end of the first connecting member 22 is connected to the operating member 21, and the lower end of the first connecting member 22 is connected to a movable member 23 of the displacement member 40 described later. The first connecting member 22 is a flexible elongated metal member, such as a wire.

Referring particularly to FIG. 4(A), a displacement member 40 is disposed inside each pivot member 30 that pivotally connects the push bar 20 and the corresponding backrest support member 19. Before describing the configuration of the displacement member 40, the pivot member 30 will be described.

The pivot member 30 includes a first case 31 connected to the lower end of the push bar 20, a second case 32 connected to the upper end of the backrest support member 19, and the pivot shaft 35 that extends through the first case 31 and the second case 32 such that the first case 31 and the second case 32 can pivot relative to each other about the pivot shaft 35. The first case 31 and the second case 32 are hollow and are fitted together to form an accommodation space that houses the displacement member 40. The first case 31 pivots together with the push bar 20, and the second case 32 pivots together with the backrest support member 19.

An inclined protrusion 33 protruding inward in the axial direction (toward the left) is provided on the right wall of the first case 31. The inclined protrusion 33 has a shape that protrudes upward and inward in the axial direction. As shown in FIG. 5(A), recesses 34 are provided on the inner peripheral wall of the first case 31 at positions 180° apart. Recesses 34 are also provided on the inner peripheral wall of the second case 32 at positions 180° apart. Protrusions 26 of a transmission member 25 described later engage with the recesses 34.

Referring to FIGS. 4(A) and 4(B), the displacement member 40 is disposed in the accommodation space formed by the first case 31 and the second case 32. The displacement member 40 is connected to the rotation lock member 50 via the second connecting member 45. The displacement member 40 is displaceable between a first position corresponding to the unlocking position of the rotation lock member 50 (FIG. 6(A)) and a second position corresponding to the locking position of the rotation lock member 50 (FIG. 6(B)) in response to operation of the operating member 21.

Specifically, the displacement member 40 includes the movable member 23, a follower member 43, and the transmission member 25 disposed between the movable member 23 and the follower member 43. The movable member 23 is connected to the operating member 21 via the first connecting member 22. The follower member 43 is connected to the rotation lock member 50 via the second connecting member 45. The transmission member 25 moves in association with movement of the movable member 23 and transmits the movement to the follower member 43.

The movable member 23 is disposed inside the first case 31 and is connected to the first connecting member 22. Accordingly, the movable member 23 moves in the up-down direction when the operating member 21 is operated. The movable member 23 has an inclined recess 24 facing the inclined protrusion 33 of the first case 31. Therefore, when the operating member 21 is operated, the movable member 23 moves along the inclined protrusion 33 and also moves inward in the axial direction.

The transmission member 25 is disposed back-to-back with the movable member 23. In the deployed state and the folded state shown in FIG. 4(A), the transmission member 25 straddles the boundary between the first case 31 and the second case 32. In the folding intermediate state shown in FIG. 4(B), the transmission member 25 is positioned within the second case 32. That is, the transmission member 25 is movable in the axial direction between the first case 31 and the second case 32.

In FIGS. 5(A)-5(C), the transmission member 25 is shown shaded. As described above, the recesses 34 are provided on the inner peripheral wall of the first case 31 at positions 180° apart, and the recesses 34 are also provided on the inner peripheral wall of the second case 32 at positions 180° apart. The protrusions 26 are also provided on the outer peripheral wall of the transmission member 25 at positions 180° apart. As a result, in the deployed state of FIG. 5(A) and the folded state of FIG. 5(C), the recesses 34 of the first case 31 are aligned with the recesses 34 of the second case 32, and the recesses 34 and the protrusions 26 of the transmission member 25 engage with each other. Accordingly, as shown in FIG. 4(A), the transmission member 25 straddles the boundary between the first case 31 and the second case 32. In contrast, in the folding intermediate state of FIG. 5(B), the recesses 34 of the first case 31 are not aligned with the recesses 34 of the second case 32. Accordingly, as shown in FIG. 4(B), the transmission member 25 is positioned within the second case 32.

As shown in FIGS. 4(A) and 5(A), the transmission member 25 has a recess at a substantially central portion thereof, and a first biasing member 28 is disposed in the recess. The first biasing member 28 is, for example, a coil spring, and the displacement member 40 is constantly biased toward a first position (FIG. 4(A)) corresponding to the unlocking position of the rotation lock member 50. The transmission member 25 has, at its lower end, an inclined portion 27 that is inclined upward and outward in the axial direction (toward the left) from below toward above.

Next, the follower member 43 will be described. The follower member 43 is held at the lower end of the second case 32 so as to be movable in the up-down direction. A wire holder 41 is fixed at a fitting portion between the second case 32 and the backrest support member 19, and the follower member 43 is held by the wire holder 41 so as to be movable in the up-down direction. An outer wire 46 is fixed to the wire holder 41, and an inner wire serving as the second connecting member 45 is provided inside the outer wire 46 so as to be movable in the up-down direction.

A second biasing member 42 is disposed between the wire holder 41 and the follower member 43, and the follower member 43 is biased upward by the second biasing member 42. The follower member 43 has an inclined portion 44 that comes into contact with the inclined portion 27 of the transmission member 25. Accordingly, the follower member 43 moves in the up-down direction in association with movement of the transmission member 25.

The follower member 43 is connected to the second connecting member 45 connected to the rotation lock member 50. Therefore, when the follower member 43 moves downward, the second connecting member 45 is pulled downward, and the rotation lock member 50 is displaced from the unlocking position to the locking position.

Next, the rear wheel 14 and the rotation lock member 50 will be described with reference to FIG. 6(A). The rear wheel 14 includes a wheel body 71 fixed to an axle 70, a tire 72 held by the wheel body 71, and a plurality of lock protrusions 73 fixed to the wheel body 71. The lock protrusions 73 are provided in a radial pattern on a side of the wheel body 71 facing the tire 72. When the rotation lock member 50 is positioned between adjacent lock protrusions 73, the rear wheel 14 is locked against rotation.

The rotation lock member 50 is provided to stop rotation of the rear wheel 14 and is displaceable between the locking position (FIG. 6(B)), in which the rear wheel 14 is locked against rotation, and the unlocking position (FIG. 6(A)), in which the rear wheel 14 is not locked against rotation. A rotation lock member 50 is fixed below each rear leg 13. The rotation lock member 50 is pivotable relative to the lock protrusions 73 of the rear wheel 14. As shown in FIG. 6(A), when the rotation lock member 50 is positioned within the profile of the rear leg 13, the rotation lock member 50 is in the unlocking position. As shown in FIG. 6(B), when the rotation lock member 50 protrudes from the rear leg 13 and is positioned between adjacent lock protrusions 73, the rotation lock member 50 is in the locking position.

The rotation lock member 50 is biased toward the locking position by a third biasing member 51. The third biasing member 51 is, for example, a torsion spring, and is fixed to a shaft of the rotation lock member 50. The rotation lock member 50 is connected to the lower end of the second connecting member 45. Accordingly, the rotation lock member 50 moves in association with movement of the displacement member 40, specifically movement of the follower member 43. Preferably, the biasing force of the third biasing member 51 is weaker than the biasing force of the second biasing member 42.

### Operation

The folding operation of the stroller 1 according to the present embodiment will now be described with reference to FIGS. 1 and 4-6. FIGS. 1(A), 4(A), 5(A) and 6(A) show the deployed state. FIGS. 1(B), 4(B), 5(B) and 6(B) show the folding intermediate state. FIGS. 1(C), 4(A), 5(C) and 6(A) show the folded state. In the stroller 1 according to the present embodiment, rotation of the rear wheels 14 is permitted in the deployed state (FIG. 1(A)) and in the folded state (FIG. 1(C)), whereas the rear wheels 14 is locked against rotation in the folding intermediate state (FIG. 1(B)). The operation will be described below in detail.

First, the deployed state of the stroller 1 will be described with reference to FIGS. 1(A), 4(A), 5(A) and 6(A). When the stroller 1 is in the deployed state shown in FIG. 1(A), the stroller 1 can be used with a child seated therein. In this state, the rotation lock member 50 is at the unlocking position where it does not engage with the lock protrusions 73 of the rear wheel 14. Therefore, the rear wheel 14 is rotatable.

When the operating member 21 is not operated, the displacement member 40 is positioned at the first position (FIG. 6(A)) corresponding to the unlocking position of the rotation lock member 50. As shown particularly in FIG. 4(A), the inclined recess 24 of the movable member 23 faces the inclined protrusion 33 and is positioned at a lower position. At the same time, the transmission member 25 is biased rightward in the axial direction by the first biasing member 28, and the follower member 43 is positioned at an upper position. As shown in FIG. 6(A), although the rotation lock member 50 is biased toward the lock position by the third biasing member 51, it is pulled upward by the second connecting member 45 and is therefore positioned at the unlocking position where it does not engage with the lock protrusions 73 of the rear wheel 14. Accordingly, when the operating member 21 is not operated, the rear wheel 14 is rotatable.

When the stroller 1 is not in use, it can be brought into the folded state shown in FIG. 1(C) via the folding intermediate state shown in FIG. 1(B). In the folded state, the front leg 11, the rear leg 13, and the push bar 20 are moved closer to each other in the front-rear direction. In addition, the front leg 11, the rear leg 13, the push bar 20, the armrest 15, and the backrest support member 19 extend generally in the up-down direction while being positioned closer to each other in the front-rear direction, and the front guard 17 extends upward. In the folding intermediate state in which the stroller 1 transitions from the deployed state to the folded state, the rear wheel 14 is locked against rotation.

To change the stroller 1 from the deployed state to the folded state, the operating member 21 of the push bar 20 is operated. The folding intermediate state of the stroller 1 will now be described with reference to FIGS. 1(B), 4(B), 5(B) and 6(B). In this state, the rotation lock member 50 is at the lock position where it engages the lock protrusions 73 of the rear wheel 14, and therefore the rear wheel 14 cannot rotate.

More specifically, when the operating member 21 is operated, the first connecting member 22 is pulled, and the displacement member 40 is positioned at the second position (FIG. 6(B)) corresponding to the locking position of the rotation lock member 50. As shown particularly in FIG. 4(B), when the first connecting member 22 is pulled, the movable member 23 moves upward. At the same time, the inclined recess 24 moves along the inclined protrusion 33, thereby moving upward and toward the left in the axial direction. Accordingly, the transmission member 25 is pushed toward the left in the axial direction against the biasing force of the first biasing member 28 and moves from a position where the transition member 25 straddles the boundary between the first case 31 and the second case 32 into the second case 32. As a result, as shown in FIGS. 5(A) and 5(B), the pivot member 30 rotates together with the push bar 20, causing the recesses 34 of the first case 31 and the recesses 34 of the second case 32 to be misaligned with each other in the circumferential direction. Since the protrusions 26 of the transmission member 25 engage with the recesses 34 of the second case 32, the transmission member 25 is held within the second case 32 as shown in FIG. 4(B).

As the transmission member 25 moves, the follower member 43 is pushed downward against the biasing force of the second biasing member 42. The inclined portion 44 of the follower member 43 moves downward along the inclined portion 27 to a lower position. As a result, as shown in FIG. 6(B), the second connecting member 45 becomes slack, allowing the biasing force of the third biasing member 51 to act. Due to the biasing force of the third biasing member 51, the rotation lock member 50 is therefore displaced to the locking position where it engages with the lock protrusions 73 of the rear wheel 14. Accordingly, the rear wheel 14 is locked against rotation.

When the stroller 1 changes from the folding intermediate state shown in FIG. 1(B) to the folded state shown in FIG. 1(C), the configuration shown in FIG. 5(C) results. The pivot member 30 rotates together with the push bar 20, and the recesses 34 of the first case 31 and the recesses 34 of the second case 32 are aligned in the circumferential direction. Since the protrusions 26 of the transmission member 25 engage with the recesses 34, the transmission member 25 returns from the position inside the second case 32 (FIG. 4(B)) to the position where the transmission 25 straddles the boundary between the first case 31 and the second case 32 (FIG. 4(A)), thereby unlocking the rear wheel 14 against rotation. Accordingly, in the folded state, the stroller 1 can be moved by holding the upwardly protruding front guard 17 and pushing the stroller 1.

### Effects

In the stroller 1 of the present embodiment, the rotation lock member 50 is displaced from the unlocking position to the locking position in association with the movement of the body frame 10 from the deployed state to the folded state, thereby locking the rear wheel 14 against rotation. As a result, the center of gravity of the stroller 1 becomes stable, and the folding operation of the stroller 1 can be stabilized. Conventionally, in order to reduce the risk that the stroller 1 tips over during the folding operation, the stroller needs to be pulled backward so that the front wheels 12 are oriented forward to stabilize the stroller body. In the present embodiment, this operation of pulling the stroller backward is not needed, thereby improving usability.

Furthermore, the operating member 21 is originally intended to perform the folding operation of the stroller 1. Since the rotation lock member 50 is displaced between the locking position and the unlocking position in association with the operation of the operation member 21, no separate operation to displace the rotation lock member 50 is needed, thereby improving operability.

In the stroller 1 of the present embodiment, the rear wheel 14 is locked against rotation during the folding intermediate state shown in FIG. 1(B). Since the rear wheel 14 is not locked against rotation in the folded state shown in FIG. 1(C), the stroller 1 can be moved by holding the upwardly protruding front guard 17 and pushing the stroller 1. Thus, operability of the stroller 1 can be improved even in the folded state.

Moreover, the stroller 1 can be realized simply by adding components such as the follower member 43, the second connecting member 45, and the rotation lock member 50 to a conventional stroller having a folding structure. Therefore, the structure of the stroller 1 does not need to be significantly modified.

### Second Embodiment

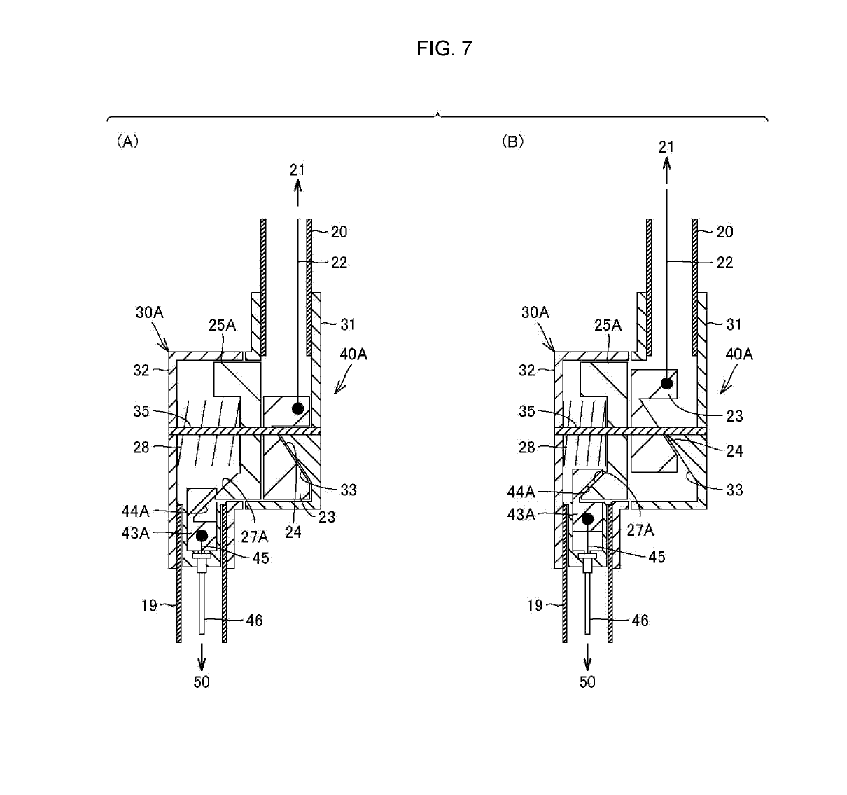

The configuration and operation of a stroller according to a second embodiment will be described with reference to FIGS. 7(A) and 7(B). The stroller of the present embodiment has substantially the same basic configuration as that of the first embodiment, but differs in the configuration of a transmission member 25A and a follower member 43A. The differences from the configuration described in the first embodiment will be mainly described in detail.

In the transmission member 25A of the present embodiment, an inclined portion 27A is inclined so as to protrude downward toward the left in the axial direction. The follower member 43A has an inclined portion 44A that is inclined so as to be recessed downward toward the left in the axial direction. The inclined portion 27A engages with the inclined portion 44A, and the follower member 43A moves in association with movement of the transmission member 25A. The follower member 43A of the present embodiment is not biased by a biasing member.

In the deployed state shown in FIG. 7(A), the inclined portion 27A of the transmission member 25A and the inclined portion 44A of the follower member 43A are offset from each other in the up-down direction. When the operating member 21 is operated in this state, the first connecting member 22 is pulled upward, causing the movable member 23 to move upward and toward the left in the axial direction. As a result, the transmission member 25A moves toward the left in the axial direction. Accordingly, the inclined portion 27A of the transmission member 25A comes into contact with the inclined portion 44A of the follower member 43A and is inserted into the recess while sliding along the inclined portion 44A. The follower member 43A thereby moves upward, and the second connecting member 45 is pulled upward.

Although not shown in the figures, the rotation lock member of the present embodiment locks the rear wheel 14 against rotation when the second connecting member 45 is pulled upward, which is opposite to the movement of the second connecting member 45 of the first embodiment described above. Thus, the rotation lock member may be configured in any manner as long as it is displaced by the second connecting member 45, and the displacement member 40 may be configured in various forms.

### Third Embodiment

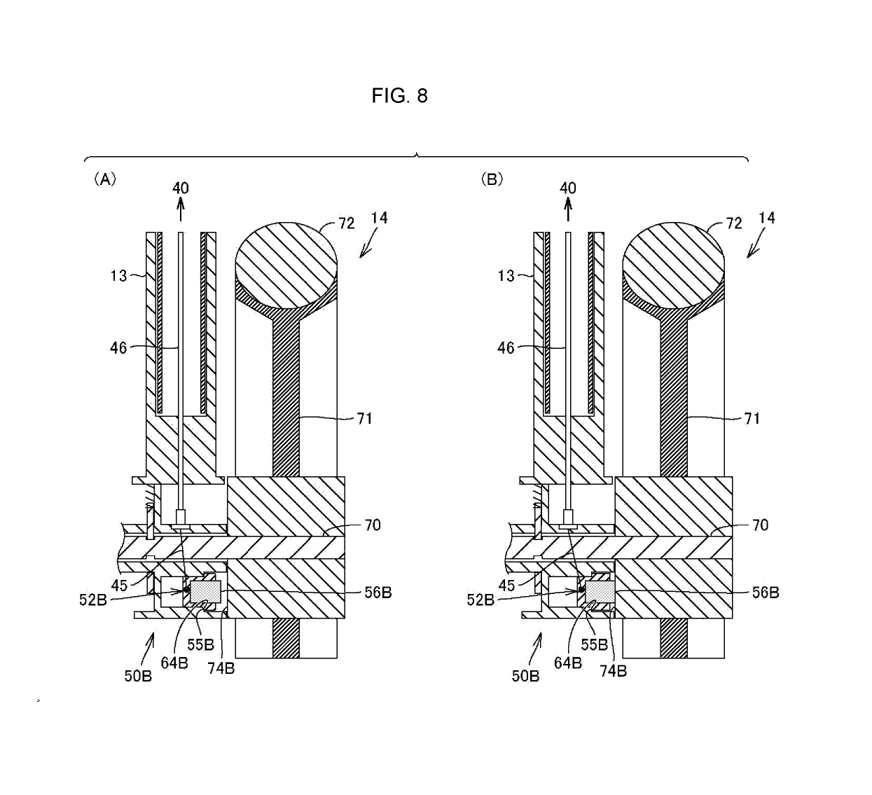

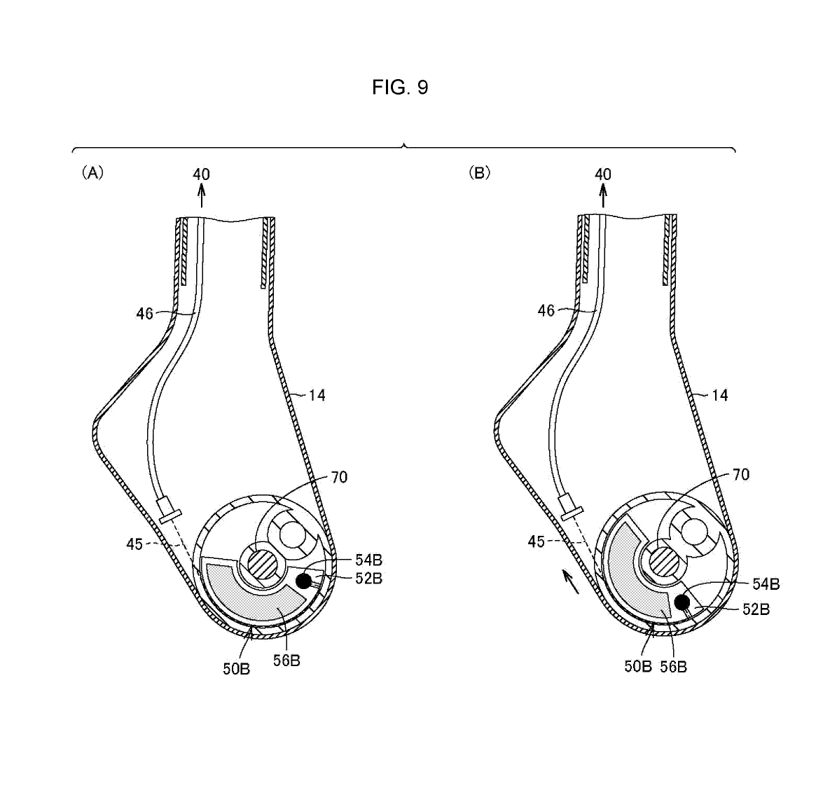

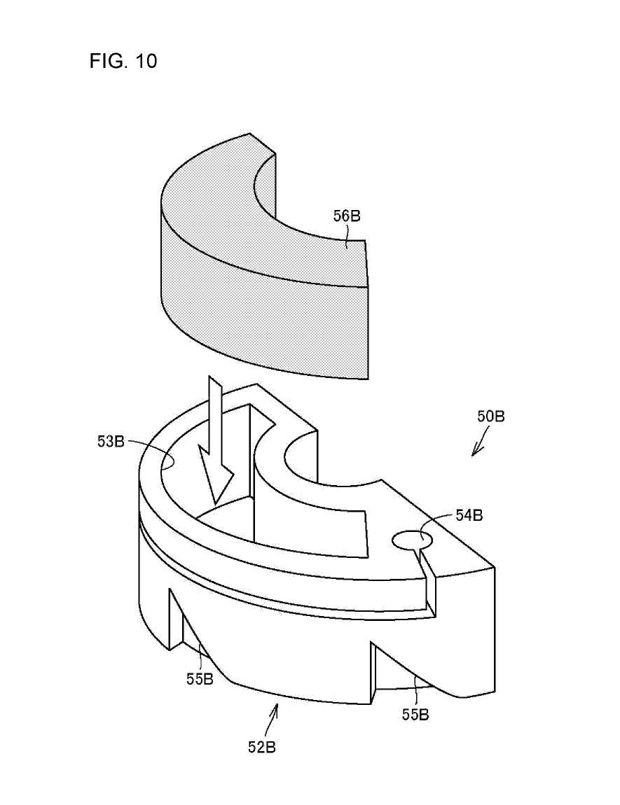

The configuration and operation of a stroller according to a third embodiment will be described with reference to FIGS. 8-10. FIG. 8 schematically shows a relationship between the rotation lock member and the rear wheel according to the third embodiment of the present invention. FIG. 8(A) shows an unlocked state and FIG. 8(B) shows a locked state. FIG. 9 shows sectional views of the rotation lock member. FIG. 9(A) shows the unlocked state and FIG. 9(B) shows the locked state. FIG. 10 is an enlarged perspective view of the rotation lock member. For ease of understanding, an elastic member 56B is shown shaded in FIGS. 8-10, and the second connecting member 45 is indicated by a dashed line in FIG. 9.

The stroller of the present embodiment has substantially the same basic configuration as that of the first embodiment, but differs in the configuration of a rotation lock member 50B. The differences from the configuration described in the first embodiment will be mainly described in detail. In the first embodiment, the rear wheel 14 is locked against rotation by positioning the rotation lock member 50 between adjacent lock protrusions 73 of the rear wheel 14. In the present embodiment, however, the rear wheel 14 is locked against rotation by pressing the rotation lock member 50B against an axle portion 74B of the rear wheel 14.

As shown in FIGS. 8(A) and 8(B), the rear wheel 14 that uses the rotation lock member 50B of the present embodiment does not include the lock protrusions 73 provided on the rear wheel 14 of the first embodiment. The rotation lock member 50B is pressed against the axle portion 74B surrounding the axle 70 of the rear wheel 14, thereby stopping rotation of the rear wheel 14. That is, the rotation lock member 50B serves as a so-called friction brake.

As shown in FIGS. 9(A), 9(B) and 10, the rotation lock member 50B includes a main body 52B and an elastic member 56B inserted into the main body 52B. As shown particularly in FIG. 10, the main body 52B has, for example, a substantially semi-cylindrical shape and is formed with an opening 53B for inserting the elastic member 56B. The main body 52B is a housing formed of a material harder than that of the elastic member 56B. A support portion 54B that supports the lower end of the second connecting member 45 is formed at an end of the main body 52B, and a groove is formed along a peripheral wall of the main body 52B. A plurality of notches 55B is formed on a lower portion of the peripheral wall of the main body 52B. The notches 55B engage with inclined portions 64B of a holder of the rear leg 13.

The elastic member 56B is inserted into the opening 53B of the main body 52B and therefore has a substantially semi-cylindrical shape corresponding to the shape of the opening 53B. The elastic member 56B is made of, for example, rubber formed of a resin material. The elastic member 56B is a portion that comes into contact with the axle portion 74B of the rear wheel 14 when the rotation lock member 50B is in the locking position shown in FIG. 8(B). Preferably, the portion of the elastic member 56B that contacts the axle portion 74B has a flat surface.

When the displacement member 40 is displaced and the second connecting member 45 is pulled upward as indicated by the arrow in FIG. 9(B), the rotation lock member 50B rotates along the axle 70. As a result, as shown in FIG. 8(B), the elastic member 56B of the rotation lock member 50B comes into contact with the axle portion 74B of the rear wheel 14 and reaches the locking position. As a result, friction is generated, and the rear wheel 14 is locked against rotation.

Since the rotation lock member 50B of the present embodiment stops rotation of the rear wheel 14 gradually by applying friction, the impact applied to the stroller body can be reduced. Accordingly, the folding operation can further be stabilized.

### Modifications Applicable to Multiple Embodiments

In the embodiments described above, the front wheels 12 are caster wheels provided with the caster mechanisms 60, and the rear wheels 14 are fixed wheels that do not swivel about a vertical axis. However, all of the wheels may instead be caster wheels provided with caster mechanisms, or at least one of the four wheels may be a caster wheel.

In the embodiments described above, the rotation lock members 50 or 50B are provided on the rear wheels 14. However, they may instead be provided on the front wheels 12, or on caster wheels provided with caster mechanisms 60, and are therefore not limited to fixed wheels. The rotation lock member 50 or 50B need only be provided on at least one of the four wheels.

In the embodiments described above, the folding operation is initiated by operating the operating member 21. However, the stroller may instead be configured such that the folding operation begins without operation of the operating member 21. For example, the operating member 21 and the first connecting member 22 may be omitted, and when the folding operation begins, the displacement member 40 or 40A may be displaced from the first position to the second position, thereby displacing the rotation lock member 50 from the unlocking position to the locking position. Furthermore, when the operating member 21 is provided, it may be provided on a portion of the body frame 10 other than the push bar 20.

In the embodiments described above, the displacement member 40 or 40A is provided at the pivot member 50 between the push bar 20 and the backrest support member 19. However, the displacement member 40 or 40A may be provided at any position on the body frame 10. In particular, although it is preferable that the displacement member 40 or 40A be provided at a portion where the body frame 10 bends during folding of the stroller, the displacement member 40 or 40A need not necessarily be provided at such a bending portion.

In the embodiments described above, the pivot shaft 35 at which the displacement member 40 or 40A is provided is disposed between the push bar 20 and the backrest support member 19. However, the pivot shaft 35 may instead be provided between other frame members that constitute the body frame 10, such as a first frame and a second frame that move closer to each other in the front-rear direction during the folding operation. The pivot shaft 35 need not necessarily be provided between the push bar 20 and the backrest support member 19.

In the first embodiment, the first biasing member 28, the second biasing member 42, and the third biasing member 51 are provided. However, these members are provided in order to stabilize the operation of locking the rear wheel 14 against rotation in association with the folding operation, and may be omitted.

In the embodiments described above, the push bar 20 of the stroller 1 is fixed in a forward-facing position. However, the push bar 20 may instead be a switchable push bar that is slidably movable between a forward-facing position and a rear-facing position.

Although multiple embodiments have been described in the present specification, individual configurations of these embodiments may be extracted and combined with each other.

Although the embodiments of the present invention have been described above with reference to the drawings, the present invention is not limited to the illustrated embodiments. Various modifications and variations may be made to the illustrated embodiments without departing from the spirit and scope of the present invention.

1. A foldable stroller comprising:
a body frame including front legs and rear legs, the body frame having different configurations in a deployed state and a folded state;
a caster mechanism provided at a lower end of at least one of the front legs or the rear legs and configured to allow a wheel to swivel; and
a rotation lock member configured to lock the wheel against rotation, the rotation lock member being displaceable between a locking position at which the wheel is locked against rotation and an unlocking position at which the wheel is not locked against rotation, wherein
the rotation lock member is configured to be displaced from the unlocking position to the locking position in association with movement of the body frame from the deployed state to the folded state.

2. The foldable stroller according to claim 1, further comprising an operating member provided on the body frame and operable to move the body frame from the deployed state to the folded state.

3. The foldable stroller according to claim 2, wherein:
the body frame further includes a first frame and a second frame connected via a pivot shaft; and
the body frame is configured to, as configurations of the first frame and the second frame change, pivot about the pivot shaft and fold such that the front legs and the rear legs move closer to each other in a front-rear direction.

4. The foldable stroller according to claim 3, further comprising a displacement member provided on the body frame and connected to the rotation lock member via a connecting member, the displacement member being displaceable between a first position corresponding to the unlocking position of the rotation lock member and a second position corresponding to the locking position of the rotation lock member in association with movement of the body frame from the deployed state to the folded state.

5. The foldable stroller according to claim 4, wherein the displacement member is provided at the pivot shaft.

6. The foldable stroller according to claim 4, wherein:
the displacement member includes
a movable member connected to the operating member via a first connecting member and configured to move in response to operation of the operating member,
a follower member connected to the rotation lock member via a second connecting member, and
a transmission member provided between the movable member and the follower member and configured to move with movement of the movable member and transmit the movement to the follower member.

7. The foldable stroller according to claim 6, wherein:
the movable member and the transmission member are movable in an axial direction of the body frame; and
the follower member is movable in an up-down direction along the body frame.

8. The foldable stroller according to claim 4, further comprising a biasing member configured to bias the displacement member toward the first position.

9. The foldable stroller according to claim 1, wherein:
the caster mechanism is provided at the lower end of the front leg, and
the rotation lock member is configured to lock a rear wheel provided at the lower end of the rear leg against rotation.
